(19) United States
(12) Patent Application Publication
(10) Pub. No.: US 2015/0335527 A1
(43) Pub. Date: Nov. 26, 2015

(54) SALON TREATMENT ASSEMBLY WITH MOVABLE SALON CHAIR AND HARD-PLUMBED FOOT BATH

(71) Applicant: EARTHLITE MASSAGE TABLES, INC., Vista, CA (US)

(72) Inventors: Jonathan William Roleder, San Diego, CA (US); James Chenevey, Encinitas, CA (US); Eric Flesey, Oceanside, CA (US)

(21) Appl. No.: 14/655,883

(22) PCT Filed: Jan. 10, 2014
(86) PCT No.: PCT/US14/11100

§ 371 Date: Jun. 26, 2015

Related U.S. Application Data
(60) Provisional application No. 61/751,415, filed on Jan. 11, 2013.

(51) Int. Cl. A61H 35/00

(52) U.S. Cl. CPC A61H 35/006; A61H 2201/0161; A61H 2201/0149; A61H 2201/50

(57) ABSTRACT

A salon treatment assembly (10) includes a foot bath (18) and a salon chair (12). The foot bath (18) is hard-plumbed and maintained in a stationary position; and a salon chair (12) is selectively movable relative to the foot bath (18) such that the foot bath (18) can alternatively be positioned in (i) a covered configuration, wherein the salon chair (12) is positioned substantially completely over the foot bath (18), and (ii) an uncovered configuration, wherein the salon chair (12) is not positioned over the foot bath (18). Moreover, the salon chair (12) can be constrained to be selectively movable in only an in-line manner along a movement axis relative to the foot bath (18).

### RELATED APPLICATION

The application claims priority on U.S. Provisional Application Ser. No. 61/751,415 filed on Jan. 11, 2013, entitled “SALON TREATMENT ASSEMBLY WITH MOVABLE SALON CHAIR AND HARD-PLUMBED FOOT BATH”. As far as is permitted, the contents of U.S. Provisional Application Ser. No. 61/751,415 are incorporated herein by reference.

### BACKGROUND

As the benefits of various salon treatments are becoming more widely appreciated, more and more people are choosing to receive salon treatments. One such popular salon treatment is the pedicure, which helps people to improve the appearance of their feet and toe nails. A salon treatment assembly, e.g., a pedicure treatment assembly, that may be used when a person is receiving a pedicure typically includes a salon chair, e.g., a pedicure chair, where the person receiving the pedicure is seated, and a foot bath where certain features of the pedicure are performed. Unfortunately, the combination of the pedicure chair and the foot bath often requires a fairly substantial amount of space while the person is receiving the pedicure and even while the person is not receiving the pedicure.

### SUMMARY

The present invention is directed toward a salon treatment assembly usable during a salon treatment, such as a pedicure. In various embodiments, the salon treatment assembly comprises a foot bath system and a salon chair. In such embodiments, the foot bath system can include a foot bath into which the person receiving the pedicure can position their feet during certain portions of the treatment.

In some embodiments, the salon treatment assembly includes a foot bath that is hard-plumbed such that the foot bath is maintained in a stationary position; and a salon chair that is selectively movable relative to the foot bath. More particularly, the salon chair is selectively movable relative to the foot bath such that the foot bath can alternatively be positioned in (i) a covered configuration, wherein the salon chair is positioned substantially completely over the foot bath, and (ii) an uncovered configuration, wherein the salon chair is not positioned over the foot bath. With this design, when the salon treatment assembly is not in use, and/or when access to the foot bath is not required, the salon chair can be positioned over the foot bath, i.e. the foot bath can be in the covered configuration, and the salon treatment assembly can have a much smaller overall footprint.

In one embodiment, the salon chair is constrained to be selectively movable in only an in-line manner along a movement axis relative to the foot bath such that the salon chair can completely cover the foot bath, i.e. the foot bath is in the covered configuration, and the salon chair can completely uncover the foot bath, i.e. the foot bath is in the uncovered configuration.

Additionally, in one embodiment, the salon treatment assembly can further comprise a locking mechanism that selectively inhibits movement of the salon chair relative to the foot bath.

Further, in certain embodiments, the salon treatment assembly can further include a foot rest that is coupled to the foot bath. In one such embodiment, the foot rest is selectively movable between (i) a contracted configuration, wherein the foot rest is positioned substantially adjacent to a ledge that is positioned around the foot bath, and (ii) an expanded configuration, wherein the foot rest is spaced apart from the ledge. Further, the salon treatment assembly can also include a release mechanism that can be selectively actuated to enable the foot rest to be moved between the contracted configuration and the expanded configuration. In one embodiment, the foot rest is biased such that the foot rest is spaced apart from the ledge.

In one embodiment, the foot bath includes a water control mechanism that controls a volume and temperature of water being added into the foot bath. Additionally, the foot bath can also include a drain control mechanism that controls a volume of water being removed from the foot bath. More specifically, in such embodiment, hot and/or cold water can be readily added to and drained from the foot bath by activating the water control mechanism, and by opening a drain at a base of the foot bath with the drain control mechanism.

Further, in one embodiment, the salon treatment assembly can include a tray that is selectively coupled to the salon chair.

In another application, the present invention is also directed toward a salon treatment assembly for use during a salon treatment that is provided relative to a surface, the salon treatment assembly comprising (A) a foot bath that is fixed in position relative to the surface; and (B) a salon chair that is selectively movable along the surface relative to the foot bath such that the foot bath can alternatively be positioned in (i) a covered configuration, wherein the salon chair is positioned substantially completely over the foot bath, and (ii) an uncovered configuration, wherein the salon chair is not positioned over the foot bath.

Additionally, in yet another application, the present invention is further directed toward a salon treatment assembly for use during a salon treatment that is provided relative to a surface, the salon treatment assembly comprising (A) a foot bath that is hard-plumbed such that the foot bath is fixed in position relative to the surface, the foot bath including a water control mechanism that controls a volume and temperature of water being added into the foot bath, and a drain control mechanism that controls a volume of water being removed from the foot bath; (B) a salon chair that is selectively movable in only an in-line manner along the surface relative to the foot bath such that the foot bath can alternatively be positioned in (i) a covered configuration, wherein the salon chair is positioned substantially completely over the foot bath, and (ii) an uncovered configuration, wherein the salon chair is not positioned over the foot bath; (C) a foot rest that is coupled to the foot bath, the foot rest being selectively movable between (i) a contracted configuration, wherein the foot rest is positioned substantially adjacent to a ledge that is positioned around the foot bath, and (ii) an expanded configuration, wherein the foot rest is spaced apart from the ledge; and (D) a release mechanism that can be selectively actuated to enable the foot rest to be moved between the contracted configuration and the expanded configuration.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective view of an embodiment of a salon treatment assembly having features of the present invention, the salon treatment assembly including a salon chair, a foot bath system and a stool system, with the foot bath system being in an uncovered configuration;

FIG. 1B is a perspective view of a portion of the salon treatment assembly illustrated in FIG. 1A, with the foot bath system being in a covered configuration;

FIG. 1C is a rear perspective view of a portion of the salon treatment assembly illustrated in FIG. 1A;

FIG. 1D is a schematic side view illustration of a portion of the salon treatment assembly illustrated in FIG. 1A;

FIG. 2A is a front perspective view of the foot bath system illustrated in FIG. 1A, the foot bath system including a foot rest that is in a contracted configuration;

FIG. 2B is a another front perspective view of the foot bath system illustrated in FIG. 2A, the foot rest being in an expanded configuration;

FIG. 2C is a simplified top view of the foot bath system illustrated in FIG. 2A;

FIG. 2D is a simplified sectional view of the foot bath system taken on line 2D-2D in FIG. 2C; and

FIG. 3 is a perspective view of another embodiment of the foot bath system.

### DESCRIPTION

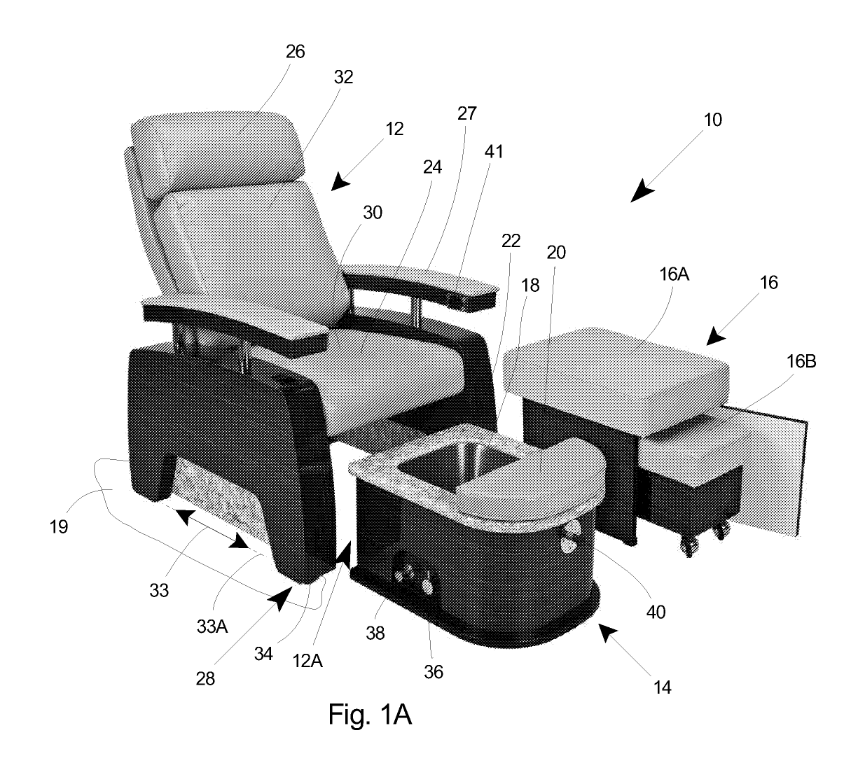

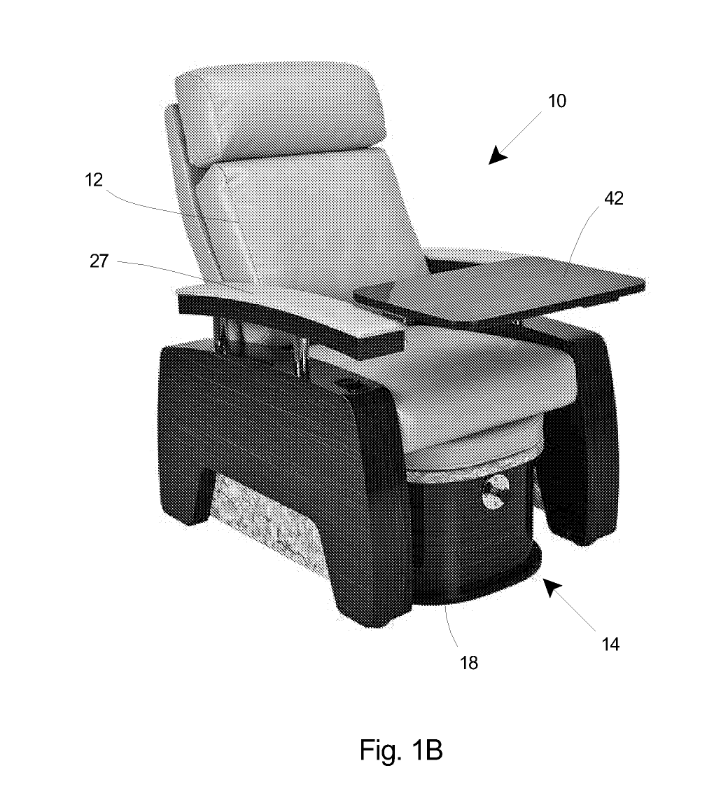

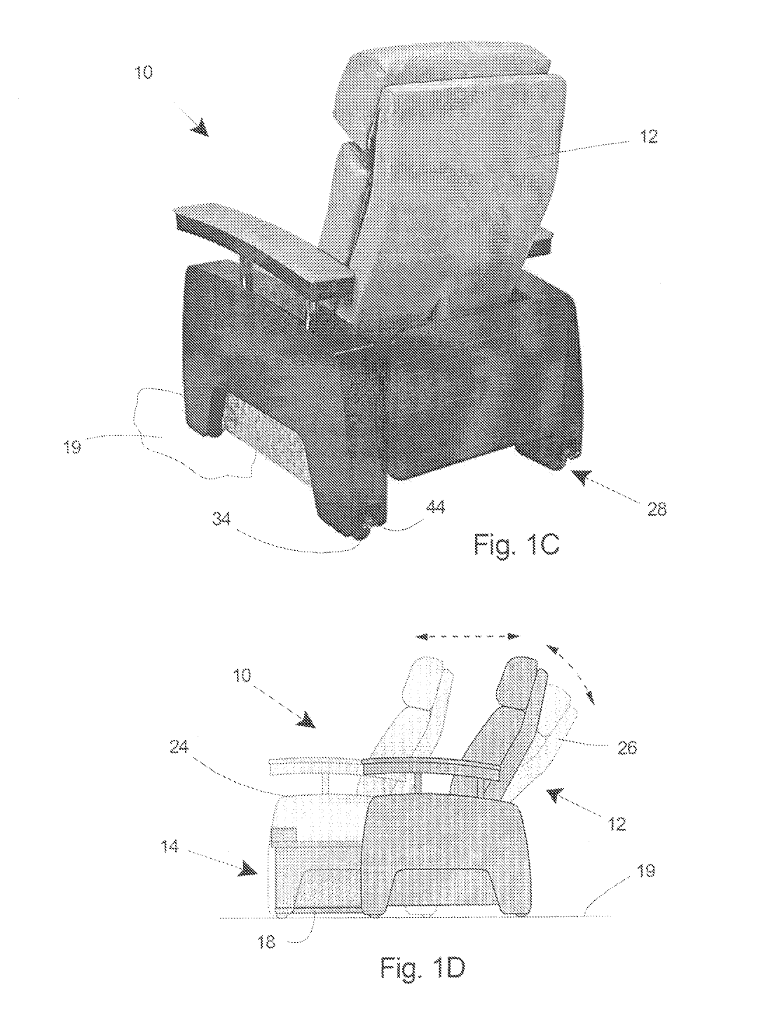

FIG. 1A is a perspective view of an embodiment of a salon treatment assembly 10 having features of the present invention. The design of the salon treatment assembly 10 can be varied. In certain embodiments, as illustrated in FIG. 1A, the salon treatment assembly 10 includes a salon chair 12, a foot bath system 14 and a stool system 16. Alternatively, the salon treatment assembly 10 can have a different design than that illustrated in FIG. 1A. For example, in some embodiments, the salon treatment assembly 10 can be designed without the stool system 16.

As an overview, in certain embodiments, the salon treatment assembly 10 is uniquely designed to provide a much smaller footprint when the salon treatment assembly 10 is not being used and/or when the foot bath system 14 is not required. More specifically, in such embodiments, the foot bath system 14 can include a foot bath 18 that is hard-plumbed, and/or is fixed and stationary in position relative to a surface 19, e.g., a floor or the ground, and the salon chair 12 can be selectively movable relative to the foot bath system 14 and/or the foot bath 18 along the surface 19 such that the foot bath system 14 and/or the foot bath 18 can be at least substantially completely covered and/or at least substantially completely uncovered by the salon chair 12. Stated in another manner, the salon chair 12 is selectively movable relative to the foot bath system 14 and/or the foot bath 18 along the surface 19 such that the foot bath system 14 and/or the foot bath 18 can alternatively be in a covered configuration (illustrated, for example, in FIG. 1B) and/or an uncovered configuration (illustrated, for example, in FIG. 1A). Stated in another manner, the salon chair 12 includes a foot bath receiving void 12A (also referred to simply as a “receiving void”) that is sized and shaped to selectively receive the foot bath system 14 and/or the foot bath 18 substantially underneath the salon chair 12 as the foot bath system 14 and/or the foot bath are in the covered configuration.

In one such embodiment, movement of the salon chair 12 can be constricted such that the salon chair 12 is selectively movable relative to the foot bath system 14 and/or the foot bath 18 in only an in-line manner (illustrated by two-headed arrow 33, i.e. along a single movement axis 33A, so that the foot bath system 14 and/or the foot bath 18 can be alternatively in the covered configuration and/or the uncovered configuration.

Further, with this design, it should be appreciated that the positioning of the salon chair 12 can be selectively adjusted during use to provide a more comfortable experience for the person receiving the salon treatment, e.g., further forward and/or further backward depending on the size or height of the person receiving the salon treatment. Still further, the adjustability of the position of the salon chair 12 relative to the foot bath 18 can make it much easier for the person receiving the salon treatment to get into the salon chair 12 prior to treatment and out of the salon chair 12 after treatment.

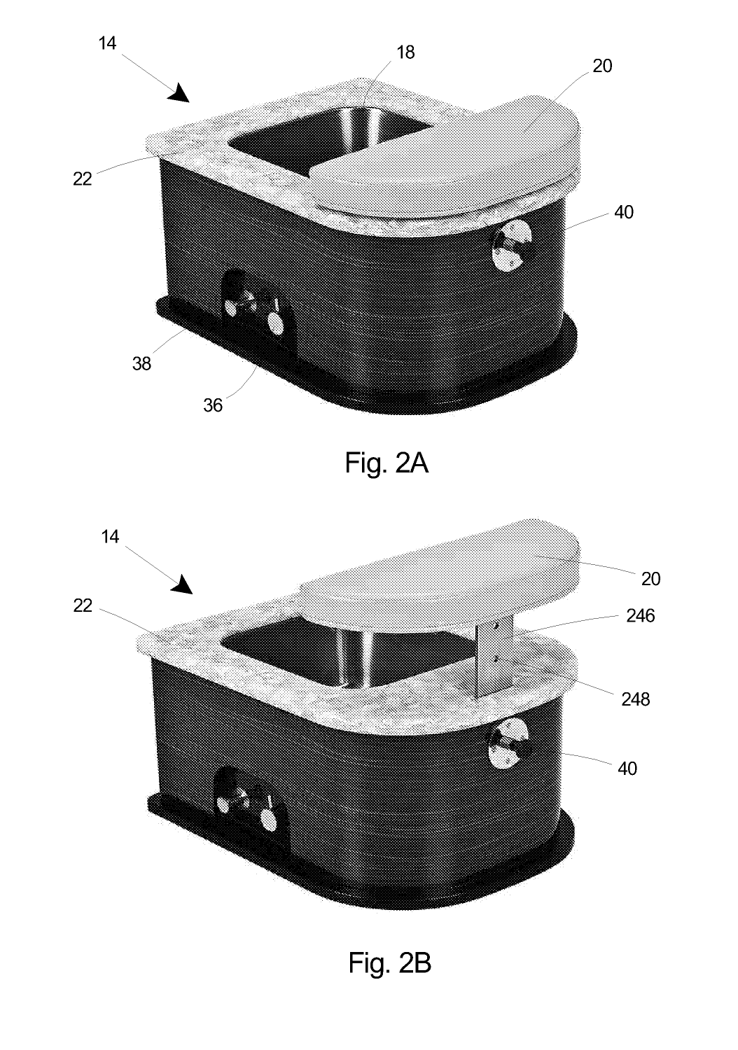

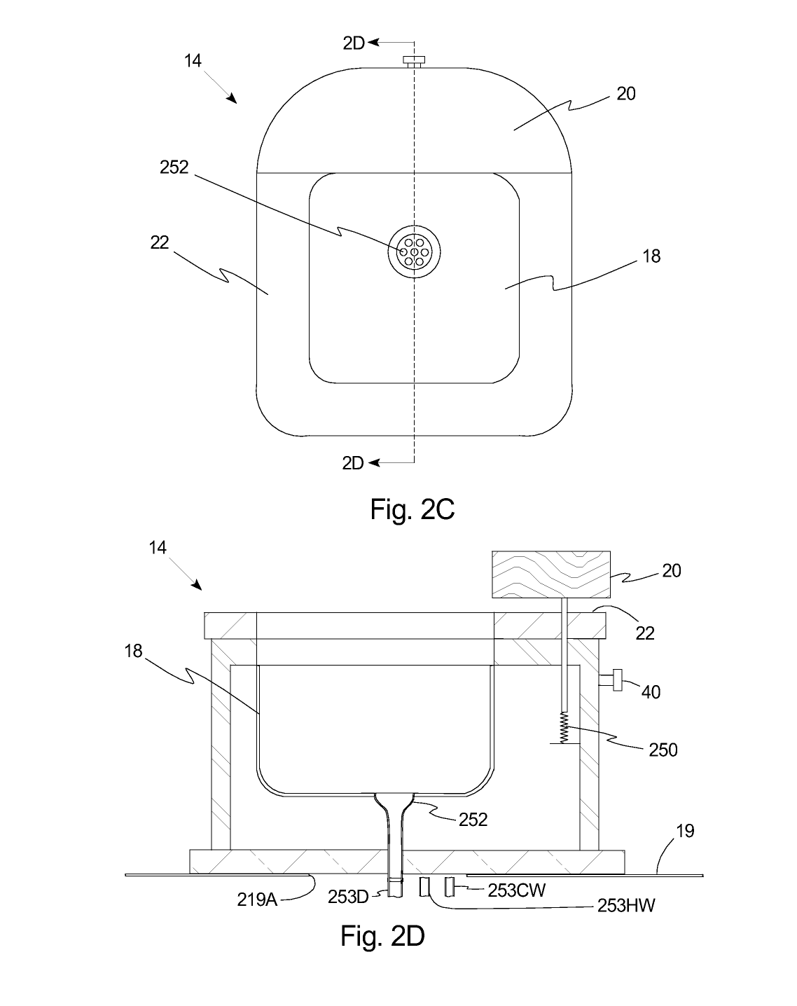

Additionally, in some embodiments, the foot bath system 14 can include a foot rest 20 that is coupled to the foot bath 18, wherein the foot rest 20 can be selectively movable between a contracted configuration (illustrated, for example, in FIG. 2A) and an expanded configuration (illustrated, for example, in FIG. 2B). When in the contracted configuration, the foot rest 20 is positioned substantially adjacent to a ledge 22 positioned around the top of the foot bath 18. Conversely, when in the expanded configuration, the foot rest 20 is positioned spaced apart from the ledge 22. It should be noted that the foot rest 20 can include multiple positions within the expanded configuration, with the foot rest 20 being positionable at different positions relative to, i.e. at different distances from, the ledge 22. Further, as described in detail herein below, the foot rest 20 can be uniquely designed to inhibit any pinching of fingers, toes, etc. between the foot rest 20 and the ledge 22.

Moreover, in one embodiment, the salon treatment assembly 10 can be designed such that all movements of the salon chair 12 and/or the foot rest 20 are conducted manually, with no requirements for electrical elements or electromechanical elements that may otherwise complicate the design and operation of the salon treatment assembly 10. With this design, the salon treatment assembly 10 can provide a low technology, high durability option, that does not require long down-time periods when repairs are needed, e.g., as compared to a salon treatment assembly that includes various electrical and/or electromechanical elements.

The salon chair 12, e.g., a pedicure chair, is designed to support a person relative to the surface 19 while the person is receiving a salon treatment, e.g., a pedicure treatment. The size, shape, dimensions and design of the salon chair 12 can be varied as desired, e.g., for various functional and/or aesthetic reasons. As shown in FIG. 1A, the salon chair 12 can include a seat support 24, a back support 26, chair arms 27, and a chair support and movement system 28. The design of each of these components can be varied depending on the specific requirements of the salon treatment assembly 10. Alternatively, the salon chair 12 can have a different design than that illustrated in FIG. 1A. For example, in one non-exclusive alternative embodiment, the salon chair 12 can be designed without the chair arms 27.

The seat support 24 supports the backside of the person receiving the salon treatment when the person is positioned on the salon chair 12. The design of the seat support 24 can be varied to suit the specific requirements of the salon chair 12 and/or for the comfort of the person receiving the salon treatment. In certain embodiments, the seat support 24 includes a seat support base (not illustrated), a seat pad (not illustrated) that is positioned on the seat support base, and a seat pad cover 30 that is positioned over the seat pad and secures the seat pad to the seat support base. Alternatively, for example, the seat support 24 can be made without the seat pad and/or the seat pad cover 30.

The seat support base is generally rigid and can be made of a rigid material such as wood, aluminum, plastic, or other suitable materials. In certain non-exclusive, alternative embodiments, the seat support base can have a thickness of approximately 0.50, 0.75, 1.00, 1.25, 1.50, 1.75, 2.00, 2.25 or 2.50 centimeters. However, other thicknesses for the seat support base can also be utilized.

The seat pad provides a cushion for the comfort of the person seated on the salon chair 12. Non-exclusive examples of suitable materials for the seat pad include foam, memory foam, fleece pads, etc. Additionally, the seat pad can be made any desired thickness.

The seat pad cover 30 secures the seat pad to the seat support base and provides a protective covering for the seat pad. Non-exclusive examples of suitable materials for the seat pad cover 30 include leather, vinyl, plastic, and cloth.

The back support 26 can support the back of the person receiving the salon treatment when the person is positioned on the salon chair 12. The design of the back support 26 can be varied to suit the specific requirements of the salon chair 12 and/or for the comfort of the person receiving the salon treatment. As illustrated, in certain embodiments, the back support 26 includes a back support base (not illustrated), a back pad (not illustrated) that is positioned on the back support base, and a back pad cover 32 that is positioned over the back pad and secures the back pad to the back support base. Alternatively, for example, the back support 26 can be made without the back pad and/or the back pad cover 32.

The back support base is generally rigid and can be made of a rigid material such as wood, aluminum, plastic, or other suitable materials. In certain non-exclusive, alternative embodiments, the back support base has a thickness of approximately 0.50, 0.75, 1.00, 1.25, 1.50, 1.75, 2.00, 2.25 or 2.50 centimeters. However, other thicknesses for the back support base can also be utilized.

The back pad provides a cushion for the comfort of the person seated on the salon chair 12. Non-exclusive examples of suitable materials for the back pad include foam, memory foam, fleece pads, etc. Additionally, the back pad can be made any desired thickness.

The back pad cover 32 secures the back pad to the back support base and provides a protective covering for the back pad. Non-exclusive examples of suitable materials for the back pad cover 32 include leather, plastic, and cloth.

As described in greater detail herein below, in some embodiments, the back support 26 can be adjustably, e.g., hingedly, secured and/or coupled to the seat support 24 such that the back support 26 can be rotated, i.e. tilted, relative to the seat support 24. Alternatively, the salon chair 12 can be designed so that the back support 26 does not tilt relative to the seat support 24.

The chair arms 27 can support the arms of the person receiving the salon treatment when the person is positioned on the salon chair 12. The design of the chair arms 27 can be varied to suit the specific requirements of the salon chair 12 and/or for the comfort of the person receiving the salon treatment. For example, in certain alternative embodiments, the chair arms 27 can be fixed and stationary relative to the rest of the salon chair 12, or the chair arms 27 can be adjustable in position relative to the rest of the salon chair 12.

In one embodiment, as illustrated, the salon chair 12 can include one or more tray supports 41 (one is illustrated in FIG. 1A) that can be used to support a hand tray 42 (illustrated in FIG. 1B) when desired. In this embodiment, the tray supports 41 are coupled and/or secured to an inside edge of the chair arms 27. Alternatively, the tray supports 41 can be positioned on the salon chair 12 in a different position and/or in a different manner.

The chair support and movement system 28 supports the salon chair 12 above the surface 19, and allows the salon chair 12 to be moved relative to the foot bath system 14 along the surface 19. In particular, as noted above, the salon chair 12 can be designed to be selectively movable relative to the foot bath system 14 and/or the foot bath 18 such that the foot bath system 14 and/or the foot bath 18 can be selectively positioned in the covered configuration (i.e. the foot bath system 14 and/or the foot bath 18 is positioned substantially within the receiving void 12A of the salon chair 12) and/or the uncovered configuration. For example, in some embodiments, the chair support and movement system 28 can include a plurality of wheels 34 (only one wheel 34 is visible in FIG. 1A) that allow the salon chair 12 to roll along the surface 19 relative to the foot bath system 14 and/or the foot bath 18. In one such embodiment, the chair support and movement system 28 includes four wheels 34, with two wheels 34 being included on each side of the salon chair 12. Alternatively, the chair support and movement system 28 can include greater than four wheels or less than four wheels, and/or the wheels 34 can be positioned in a different manner than illustrated and described herein. Still alternatively, the chair support and movement system 28 can have a different design. For example, in one non-exclusive, alternative embodiment, the chair support and movement system 28 can include a rail system (not illustrated), which can guide the movement of the salon chair 12 relative to the foot bath system 14 and/or the foot bath 18.

Moreover, in one embodiment, the chair support and movement system 28 can be designed such that the salon chair 12 is selectively movable (back and forth) relative to the foot bath system 14 and/or the foot bath 18 in only an in-line (linear) manner (illustrated by two-headed arrow 33) along the linear movement axis 33A to enable the foot bath system 14 and/or the foot bath 18 to be selectively positioned in the covered configuration and/or the uncovered configuration. For example, in such embodiment, the plurality of wheels 34 can be constricted to allow the salon chair 12 to roll only in an in-line manner, i.e. only along the single movement axis 33A.

The size, shape, dimensions and design of the foot bath system 14, and the various components of the foot bath system 14, can be varied as desired, e.g., for various functional and/or aesthetic reasons. As illustrated in FIG. 1A, the foot bath system 14 includes the foot bath 18, the ledge 22 that is positioned around the top of the foot bath 18, and the foot rest 20 that is coupled to the foot bath 18. Alternatively, the foot bath system 14 can have a different design. For example, the foot bath system 14 can be designed without the foot rest 20.

The foot bath 18 provides a place for the person receiving the salon treatment to place their feet, e.g., during portions of a pedicure treatment. In certain embodiments, as noted above, the foot bath 18 is hard-plumbed such that the foot bath 18 is maintained in a singular position, i.e. the foot bath 18 is fixed and stationary relative to the surface 19. For example, the foot bath system 14 and/or the foot bath 18 can be mounted on, above and/or within the surface 19 along which the salon chair 12 moves. Additionally, the foot bath system 14 and/or the foot bath 18 can be mounted, at least in part, above and/or within a surface aperture 219A (illustrated in FIG. 2D), such that the foot bath 18 can be hard-plumbed with access to fixed plumbing features, e.g., water pipes, drain pipes, etc., that enable water to be selectively added to and/or drained from the foot bath 18.

Further, as illustrated in FIG. 1A, the foot bath system 14 can include (i) a water control mechanism 36, which controls the adding of a volume of hot and/or cold water to the foot bath 18 by selectively turning on the hot and/or cold water; and (ii) a drain control mechanism 38, which controls the removal, i.e. draining, of a volume of the water from the foot bath 18 by selectively opening a drain 252 (illustrated in FIG. 2C) at a base of the foot bath 18. It should be appreciated that the water control mechanism 36 and the drain control mechanism 38 can be positioned in any suitable location for purposes of providing the desired control of adding water to and/or draining water from the foot bath 18.

Alternatively, in one embodiment, the foot bath 18 can have access to flexible plumbing features that allow for certain movements of the foot bath 18 relative to the surface 19. Still alternatively, in another embodiment, the foot bath 18 can be non-plumbed, such that water has to be manually added to and/or removed from the foot bath 18.

As provided above, the foot rest 20 can be coupled to the foot bath 18. Additionally, as provided above and as described in greater detail herein below, the foot rest 20 can be selectively movable between the contracted configuration, wherein the foot rest 20 is positioned substantially adjacent to the ledge 22, and the expanded configuration, wherein the foot rest 20 is positioned spaced apart from the ledge 22. Further, as illustrated, the foot bath system 18 can also include a release mechanism 40 that when activated allows the foot rest 20 to move and/or be moved relative to the ledge 22, i.e. between the contracted configuration and the expanded configuration and/or between various alternative positions within the expanded configuration. It should be appreciated that the release mechanism 40 can be positioned in any suitable location within the foot bath system 14 for purposes of activating the foot rest 20 so that the foot rest 20 can move and/or be moved between the contracted configuration and the expanded configuration.

The stool system 16 can provide a place for the treatment provider to be positioned, e.g., seated, while providing a salon treatment, e.g., a pedicure, and/or the stool system 16 can provide an alternative device on which the person receiving the treatment can rest their legs and/or feet during the salon treatment. As shown in FIG. 1A, the stool system 16 can include a non-wheeled stool 16A and a wheeled stool 16B. The non-wheeled stool 16A and the wheeled stool 16B can be positioned in any desired manner during use to provide desired comfort to the person receiving the salon treatment and/or to the treatment provider. Additionally, in one non-exclusive embodiment, as shown, the wheeled stool 16B can be somewhat smaller than the non-wheeled stool 16A such that the wheeled stool 16B can fit underneath the non-wheeled stool 16A when not being used. With such design, the overall footprint of the stool system 16 and the salon treatment assembly 10 can be made smaller.

FIG. 1B is a perspective view of a portion of the salon treatment assembly 10 illustrated in FIG. 1A. In particular, FIG. 1B is a perspective view of the salon chair 12 and the foot bath system 14, with the stool system 16 being omitted for purposes of clarity. Additionally, as illustrated in FIG. 1B, the salon chair 12 has been moved relative to the foot bath system 14 and/or the foot bath 18 such that the foot bath system 14 and/or the foot bath 18 is now in the covered configuration. Stated in another manner, as shown in FIG. 1B, the salon chair 12 has been moved relative to the foot bath system 14 and/or the foot bath 18 such that the foot bath system 14 and/or the foot bath 18 is at least substantially covered by the salon chair 12. As illustrated, in this configuration, the salon treatment assembly 10 has a much smaller footprint when the foot bath system 14 is not in use and/or is not needed.

Further, as shown in the embodiment illustrated in FIG. 1B, the salon treatment assembly 10 can further include the hand tray 42 that is usable to support the hands of the person receiving the salon treatment. For example, the hand tray 42 can be used when the person is receiving a manicure.

As shown, the hand tray 42 can be selectively coupled to one or more chair arms 27 of the salon chair 12, e.g., via the tray supports 41 (illustrated in FIG. 1A). Alternatively, the hand tray 42 can be coupled to the salon chair 12 in a different manner than that illustrated in FIG. 1B.

FIG. 1C is a rear perspective view of a portion of the salon treatment assembly 10 illustrated in FIG. 1A. In particular, FIG. 1C illustrates a rear perspective view of the salon chair 12, with the foot bath system 14 not being visible as the foot bath system 14 is at least substantially underneath the salon chair 12 in the covered configuration. Additionally, in FIG. 1C, the stool system 16 has again been omitted for purposes of clarity.

FIG. 1C also illustrates further details of one embodiment of the chair support and movement system 28. For example, FIG. 1C illustrates that in one embodiment, the chair support and movement system 28 can further include a locking mechanism 44 that selectively inhibits movement of the salon chair 12 along the surface 19 when desired. More specifically, as shown in this embodiment, the locking mechanism 44 can be selectively activated such that one or more of the wheels 34 can be locked in position in order to inhibit movement of the wheels 34, and thus the salon chair 12, along the surface 19. The locking mechanism 44 can have any suitable design that enables any movement of the salon chair 12, e.g., the wheels 34, to be effectively inhibited.

FIG. 1D is a schematic side view illustration of a portion of the salon treatment assembly 10 illustrated in FIG. 1A. In particular, FIG. 1D illustrates certain movements of the salon chair 12. For example, FIG. 1D illustrates how the salon chair 12 can be moved along the surface 19 relative to the foot bath system 14 and/or the foot bath 18 such that the foot bath system 14 and/or the foot bath 18 can be alternatively positioned in the uncovered configuration and the covered configuration. Additionally, FIG. 1D also illustrates how in certain embodiments, the back support 26 can be adjustably, e.g., hingedly, coupled and/or secured to the seat support 24 such that the back support 26 can be rotated, i.e. tilted, relative to the seat support 24.

In certain embodiments, the back support 26 can tilt relative to the seat support 24 by between approximately ten degrees and forty degrees. In one specific, non-exclusive embodiment, the back support 26 can tilt relative to the seat support 24 by approximately twenty-five degrees. Alternatively, the salon chair 12 can be designed such that the allowable degree of tilt of the back support 26 relative to the seat support 24 can be greater than forty degrees or less than ten degrees. Still alternatively, the salon chair 12 can be designed so that the back support 26 does not tilt relative to the seat support 24.

FIG. 2A is a front perspective view of the foot bath system 14 illustrated in FIG. 1A. In particular, FIG. 2A illustrates the foot bath 18, and the water control mechanism 36 and the drain control mechanism 38 that control the adding of water to and draining of water from the foot bath 18. Additionally, FIG. 2A illustrates that the foot bath system 14 includes the foot rest 20, with the foot rest 20 being shown in the contracted configuration. Further, FIG. 2A also illustrates the release mechanism 40 that allows the foot rest 20 to move and/or be moved relative to the ledge 22 between the contracted configuration and the expanded configuration (illustrated, for example, in FIG. 2B).

As provided above, when the foot rest 20 is in the contracted configuration, the foot rest 20 is positioned substantially adjacent to the ledge 22 positioned around the top of the foot bath 18. Conversely, when the foot rest 20 is in the expanded configuration, the foot rest 20 is positioned spaced apart from the ledge 22.

FIG. 2B is another front perspective view of the foot bath system 14 illustrated in FIG. 2A. As illustrated in FIG. 2B, the foot rest 20 has been moved to the expanded configuration, with the foot rest 20 being spaced apart from the ledge 22.

It should be noted that the foot rest 20 can include multiple positions within the expanded configuration, with the foot rest 20 being positionable at different positions relative to, i.e. different distances from, the ledge 22. For example, in the embodiment illustrated in FIG. 2B, the foot rest 20 can be adjusted to a plurality of different discrete positions within and/or as part of the expanded configuration. More specifically, in this embodiment, the foot rest 20 includes a support post 246 having a plurality of apertures 248 that can be selectively engaged by the release mechanism 40. The number of apertures 248, and thus the number of alternative positions for the foot rest 20 from the contracted configuration to the alternative settings within the expanded configuration, i.e. from a minimum expanded configuration to a maximum expanded configuration, can be varied. Alternatively, the foot rest 20 can be infinitely adjustable along a continuum from the contracted configuration to a maximum expanded configuration, depending on the design of the release mechanism 40.

Further, in certain embodiments, the foot rest 20 can be biased such that the foot rest 20 is spaced apart from the ledge 22, e.g., by between two and eight centimeters, when the release mechanism 40 has been activated to allow movement of the foot rest 20. For example, the foot rest 20 can include a resilient mechanism 250 (illustrated in FIG. 2D), e.g., a spring, such that the foot rest 20 is spaced apart from the ledge 22 when the release mechanism 40 has been activated to allow movement of the foot rest 20. With this design, any potential pinching of fingers, toes, etc. between the base of the foot rest 20 and the ledge 22 is inhibited, even if the release mechanism 40 has been activated and the foot rest 20 is allowed to fall from the expanded configuration toward the contracted configuration. In such embodiments, when the release mechanism 40 has been activated and the foot rest 20 is allowed to fall, the foot rest 20 does not fall all the way to the contracted configuration; rather, the foot rest 20, due to the presence of the resilient mechanism 250, only falls as far as the biased position noted above, wherein the foot rest 20 is still spaced apart from the ledge 22. Moreover, with such design, the foot rest 20 must be manually moved the final distance to the contracted configuration, i.e. such that the foot rest 20 is positioned substantially adjacent to the ledge 22, and such movement cannot be accomplished merely due to the forces of gravity.

FIG. 2C is a simplified top view of the foot bath system 14 illustrated in FIG. 2A. In particular, FIG. 2C provides a simplified top view of the foot bath 18, the ledge 22 and the foot rest 20 that is coupled to the foot bath 18. Additionally, FIG. 2C illustrates that the foot bath 18 includes a drain 252 to enable the water to be selectively drained from foot bath 18 due to activation of the drain control mechanism 38 (illustrated in FIG. 1A).

FIG. 2D is a simplified sectional view of the foot bath system 14 taken on line 2D-2D in FIG. 2C. In particular, FIG. 2D illustrates that the surface 19 can include the surface aperture 219A, and the foot bath system 14 can be mounted above the surface aperture 219A. With this design and positioning of the foot bath system 14, the foot bath 18 can be hard-plumbed with access to plumbing features, e.g., hot water pipes 253HW, cold water pipes 253CW, drain pipes 253D, etc., that enable water to be selectively added to and/or drained from the foot bath 18. It should be appreciated that the hot water pipe 253HW and the cold water pipe 253CW illustrated in FIG. 2D are coupled to the water control mechanism 36 (illustrated in FIG. 1A). Additionally, it should be appreciated that the drain pipe 253D illustrated in FIG. 2D is coupled to the drain 252, with the drain 252 being selectively opened and closed via the drain control mechanism 38 (illustrated in FIG. 1A).

Additionally, FIG. 2D illustrates certain features of the foot bath system 14 that were not otherwise visible in the previous Figures. For example, FIG. 2D illustrates the resilient mechanism 250 that biases the foot rest 20 to be spaced apart from the ledge 22, i.e. to be in the expanded configuration. As noted above, the biasing of the foot rest 20 to be spaced apart from the ledge 22 inhibits any potential pinching of fingers, toes, etc. between the base of the foot rest 20 and the ledge 22, i.e. when the release mechanism 40 for the foot rest 20 is activated.

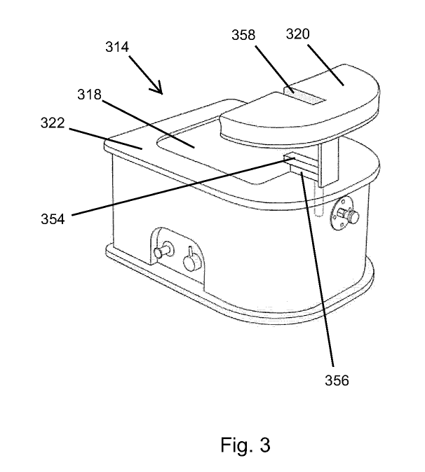

FIG. 3 is a perspective view of another embodiment of the foot bath system 314. The foot bath system 314 is somewhat similar to the foot bath system 14 illustrated and described in detail above. For example, the foot bath system 318 includes a foot bath 318 and a foot rest 320 that are somewhat similar to the foot bath 18 and the foot rest 20 illustrated and described above. Accordingly, various details of the foot bath 318 and the foot rest 320 will be not repeated herein.

However, in this embodiment, the foot bath 318 includes a faucet 354 that is mounted above the level of the ledge 322, e.g., via the use of a spacer 356 that is positioned between the faucet 354 and the ledge 322; and the foot rest 320 has a slightly different design and/or shape to accommodate the positioning of the faucet 354. Stated in another manner, in this embodiment, the foot rest 320 has a slightly different design to enable the positioning of the faucet 354 above the level of the ledge 322 for purposes of providing water to the foot bath 318.

As illustrated in FIG. 3, in this embodiment, the foot rest 320 includes a cutout portion 358 that is sized and shaped to fit about and/or accommodate the positioning of the faucet 354. In one embodiment, as illustrated, the cutout portion 358 can be substantially rectangle shaped. Alternatively, the cutout portion 358 can be another suitable shape.

While a number of exemplary aspects and embodiments of a salon treatment assembly 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A salon treatment assembly comprising:
a foot bath that is hard-plumbed such that the foot bath is maintained in a stationary position; and
a salon chair that is selectively movable relative to the foot bath such that the foot bath can alternatively be positioned in (i) a covered configuration, wherein the salon chair is positioned substantially completely over the foot bath, and (ii) an uncovered configuration, wherein the salon chair is not positioned over the foot bath.

2. The salon treatment assembly of claim 1 wherein the salon chair is constrained to be selectively movable in only an in-line manner along a movement axis relative to the foot bath.

3. The salon treatment assembly of claim 1 further comprising a locking mechanism that selectively inhibits movement of the salon chair relative to the foot bath.

4. The salon treatment assembly of claim 1 further including a foot rest that is coupled to the foot bath.

5. The salon treatment assembly of claim 4 wherein the foot rest is selectively movable between (i) a contracted configuration, wherein the foot rest is positioned substantially adjacent to a ledge that is positioned around the foot bath, and (ii) an expanded configuration, wherein the foot rest is spaced apart from the ledge.

6. The salon treatment assembly of claim 5 further comprising a release mechanism that can be selectively actuated to enable the foot rest to be moved between the contracted configuration and the expanded configuration.

7. The salon treatment assembly of claim 5 wherein the foot rest is biased such that the foot rest is spaced apart from the ledge.

8. The salon treatment assembly of claim 1 wherein the foot bath includes a water control mechanism that controls a volume and temperature of water being added into the foot bath.

9. The salon treatment assembly of claim 1 wherein the foot bath includes a drain control mechanism that controls a volume of water being removed from the foot bath.

10. The salon treatment assembly of claim 1 further comprising a tray that is selectively coupled to the salon chair.

11. A salon treatment assembly for use during a salon treatment that is provided relative to a surface, the salon treatment assembly comprising:
a foot bath that is fixed in position relative to the surface; and
a salon chair that is selectively movable along the surface relative to the foot bath such that the foot bath can alternatively be positioned in (i) a covered configuration, wherein the salon chair is positioned substantially completely over the foot bath, and (ii) an uncovered configuration, wherein the salon chair is not positioned over the foot bath.

12. The salon treatment assembly of claim 11 wherein the salon chair is constrained to be selectively movable in only an in-line manner along the surface relative to the foot bath.

13. The salon treatment assembly of claim 11 further comprising a locking mechanism that selectively inhibits movement of the salon chair along the surface relative to the foot bath.

14. The salon treatment assembly of claim 11 further including a foot rest that is coupled to the foot bath.

15. The salon treatment assembly of claim 14 wherein the foot rest is selectively movable between (i) a contracted configuration, wherein the foot rest is positioned substantially adjacent to a ledge that is positioned around the foot bath, and (ii) an expanded configuration, wherein the foot rest is spaced apart from the ledge.

16. The salon treatment assembly of claim 15 further comprising a release mechanism that can be selectively actuated to enable the foot rest to be moved between the contracted configuration and the expanded configuration.

17. The salon treatment assembly of claim 15 wherein the foot rest is biased such that the foot rest is spaced apart from the ledge.

18. The salon treatment assembly of claim 11 wherein the foot bath includes a water control mechanism that controls a volume and temperature of water being added into the foot bath; and a drain control mechanism that controls a volume of water being removed from the foot bath.

19. A salon treatment assembly for use during a salon treatment that is provided relative to a surface, the salon treatment assembly comprising:
a foot bath that is hard-plumbed such that the foot bath is fixed in position relative to the surface, the foot bath including a water control mechanism that controls a volume and temperature of water being added into the foot bath, and a drain control mechanism that controls a volume of water being removed from the foot bath;
a salon chair that is selectively movable in only an in-line manner along the surface relative to the foot bath such that the foot bath can alternatively be positioned in (i) a covered configuration, wherein the salon chair is positioned substantially completely over the foot bath, and (ii) an uncovered configuration, wherein the salon chair is not positioned over the foot bath;
a foot rest that is coupled to the foot bath, the foot rest being selectively movable between (i) a contracted configuration, wherein the foot rest is positioned substantially adjacent to a ledge that is positioned around the foot bath, and (ii) an expanded configuration, wherein the foot rest is spaced apart from the ledge; and
a release mechanism that can be selectively actuated to enable the foot rest to be moved between the contracted configuration and the expanded configuration.

20. The salon treatment assembly of claim 19 further comprising a locking mechanism that selectively inhibits movement of the salon chair along the surface relative to the foot bath.
